(19) United States
(12) Patent Application Publication
(10) Pub. No.: US 2015/0190939 A1
(43) Pub. Date: Jul. 9, 2015

(54) APPARATUS AND METHOD FOR SLICING FOOD PRODUCTS

(71) Applicant: Weber Maschinenbau GmbH Breidenbach, Breidenbach (DE)

(72) Inventors: Jochen Gerlach, Dautphetal (DE); Philip Karl, Frankenberg (DE); Michael Knauf, Amoeneburg (DE); Andreas Runkel, Biedenkopf (DE); Thorsten Schneider, Weimar (DE)

(21) Appl. No.: 14/577,370

(22) Filed: Dec. 19, 2014

(30) Foreign Application Priority Data
Jan. 8, 2014 (DE) 102014100159.1

(51) Int. Cl. B26D 7/06

(52) U.S. Cl. CPC B26D 7/06

(57) ABSTRACT

An apparatus, in particular a high-performance slicer, for slicing food products such as in particular sausage, cheese, ham and/or the like, comprises a product feed which feeds a product to be sliced to a cutting plane in which a cutting blade moves adjacent to a cutting edge, in particular in a rotating and/or a planetary revolving motion. The cutting apparatus comprises means to rotate the product fed to the cutting plane about an axis, in particular about a longitudinal axis of the product, at least over a predefinable angular range during the slicing operation.

The present invention relates to an apparatus, in particular to a high-performance slicer, for slicing food products such as in particular sausage, cheese, ham and/or the like, comprising a product feed which feeds a product to be sliced to a cutting plane in which a cutting blade moves adjacent to a cutting edge, in particular in a rotating and/or a planetary revolving motion. It further relates to a method for slicing food products of the kind set forth in the preamble of claim 17.

Automatic cutting apparatus for food products, in particular high-performance slicers, are generally known. As a rule, they comprise a circular blade or a scythe-like blade, a product feed having a cutting edge, which can be formed as a cutting screen provided with apertures, as a termination at the blade side and a deposition surface such as in particular a portioning belt or the like for depositing the cut-off product slices and for forming portions.

The product feed and the cutting blade are typically located at a right angle to one another and also in a fixed position during the slicing operation so that the product feed or its conveying devices such as product holders and/or holding down devices always effect an advancement in the direction of the cutting blade. If necessary, the product can also be moved in the opposite direction and can, for example, be retracted for blank cuts.

Cutting apparatus of the initially named kind with which an oblique cutting takes place in a horizontal or vertical setting with respect to the cutting plane are already known from documents DE 198 37 644 B4 and DE 198 37 645 B4. Both serve the object of achieving oval product slices which have a uniform thickness throughout.

Slices should be cut off from the product as continuously as possible using the previously named conventional cutting apparatus, the slices being of uniform thickness and having the same shape throughout. In specific cases, however, there is a need to produce irregular parts from the product and/or to produce an overlap in the forming of portions.

It is thus the underlying object of the invention to provide an apparatus and a method of the initially named kind with which irregular parts can also be produced from the product without problem and/or with which an overlap can be achieved in the stacking of cut product slices.

This object is satisfied in accordance with the invention with respect to the apparatus in that means are provided to rotate the product fed to the cutting plane about an axis at least over a predefinable angular range during the slicing operation.

Due to this configuration, there is now the possibility of also producing irregular parts from the product and/or to effect an overlap in the stacking of cut product slices. If, for example, a product with a non-circular or irregular outer contour rotates during the slicing operation, a stack or an overlap with an irregular marginal offset results on the deposition of the cut-off parts. In this respect, the product can be fed to the cutting plane in a perpendicular or also oblique manner. The axis about which the product is rotated during the slicing and which is simply called the axis of rotation in the following can coincide with the longitudinal axis of the product. This is, however, not compulsory. It is also possible to rotate the product about an axis which includes an angle, in particular an acute angle, with the longitudinal product axis or which is skewed with respect to the longitudinal product axis. The feed direction of the product does not need to extend in parallel either with the longitudinal axis of the product or with the axis of rotation of the product or with the axis of rotation of the cutting blade.

The rotary movement of the product in combination with the feed movement of the product in the direction of the cutting plane can consequently result in movements of the front product end which can be as complex as desired in order in this manner to achieve a high degree of irregularity of the parts cut off by means of the cutting blade.

The product feed is preferably rotatable and the product can be rotated about the axis of rotation via the product feed. In this respect, the product can be fixed in the product feed such that it is taken along by the product feed on a rotation thereof, with the advancing of the product in the direction of the cutting plane simultaneously being ensured.

Both the product feed and the cutting edge are advantageously each rotatable about the axis of rotation. It is thereby ensured that the product to be sliced is always reliably supported at the cutting edge independently of the respective rotational position in cutting.

The product feed and the cutting edge are rotatable in the same direction, for example. In this respect, the product feed and the cutting edge can in particular be rotatable about the axis of rotation together. In this respect, the product feed and the cutting edge can rotate at the same sped or also differently rapidly.

It can also be of advantage in specific cases if the cutting edge is rotatable about the axis of rotation at a lower sped than the product feed.

The product feed and the cutting edge are preferably coupled to one another mechanically and/or at the drive side.

In general, the product feed and the cutting edge can be rotatable in the same direction or also in opposite directions. In the first case, such a configuration of the cutting apparatus in accordance with the invention is in particular also conceivable in which the cutting edge is taken along by the rotating product. As already mentioned, the product feed and the cutting edge can, however, also be coupled mechanically or at the drive side. In general, however, a separate drive of the product feed and of the cutting edge is also conceivable, with the drives expediently being synchronized in this case.

In the case that the product feed and the cutting edge are also rotatable in opposite directions, they can also in particular be coupled mechanically and/or at the drive side.

In accordance with an alternative exemplary embodiment of the cutting apparatus in accordance with the invention, the cutting edge is rotationally fixedly supported. In this case, only the product feed therefore rotates and accordingly the product to be sliced.

The product to be sliced can be fed to the cutting plane in a perpendicular manner or also obliquely. It is in particular of advantage if the feed direction in which the product to be sliced is fed to the cutting plane by the product feed is variably adjustable relative to the normal of the cutting plane.

In this respect, in accordance with a preferred embodiment of the cutting apparatus in accordance with the invention, the feed direction in which the product to be sliced is fed to the cutting plane by the product feed can be varied relative to the normal of the cutting plane during the slicing operation. In this respect, the product to be sliced which is fed to the cutting plane by the product feed can be pivotable relative to the normal of the cutting plane, e.g. in a plane, in particular in the horizontal and/or vertical direction, during the slicing operation. Alternatively to such an oscillating movement of the product taking place in a plane, the product can also be caused to make a kind of wobble movement in that the product is in particular moved by means of the product feed such that, for example, the longitudinal axis of the product describes a conical surface. In this respect, the product additionally rotates about the axis of rotation which e.g. coincides with the longitudinal product axis. A wobble-like movement of the product can alternatively also be achieved in that the product is rotated about an axis of rotation which does not coincide with the longitudinal product axis.

The product feed can be rotatable together with the product to be sliced about the longitudinal axis of the product by 360° or also only over an angular range smaller than 360°.

In the latter case, the product feed can in particular be drivable together with the product to be sliced to make a rocking movement about the axis of rotation, i.e. the product feed together with the product moves alternately in the one direction of rotation and in the opposite direction of rotation, and indeed by equal or different angular amounts relative to a reference angle position which can generally be any desired. In this respect, the product feed can be drivable together with the product to be sliced to make a varying rocking movement about the axis of rotation over a varying angular range. In this manner, a particularly high irregularity of the parts cut off from the product can be achieved, in particular with respect to a variation of the thickness of the sliced product slices.

The product to be sliced can be fed to the cutting plane by the product feed, for example, in a constant direction different from its normal. A kind of snippet cut can be produced by the oblique feed of the product to be sliced in combination with the rotation of the product, with the cut off parts being able to vary in thickness from one margin to another. Furthermore, it is possible to influence the areal size of the cut-off parts or snippets via an additional variation of the product advancement, i.e. of the speed at which the product is fed to the cutting plane, since the cut surface of the parts or snippets also increases with their thickness due to the oblique angle of engagement of the product with respect to the cutting plane.

In accordance with an alternative advantageous embodiment of the cutting apparatus in accordance with the invention, the product to be sliced can be fed to the cutting plane at an angle of engagement variable during the slicing operation. The product feed can therefore in particular be pivoted slightly in a horizontal and/or vertical direction during the slicing operation while maintaining the rotation about the longitudinal axis of the product, whereby different parts or snippets and portion shapes result.

It is in particular also of advantage if the rotational speed of the product feed, the direction of rotation of the product feed, the feed speed, the direction of rotation of the cutting blade and/or the rotational speed of the cutting blade are variably adjustable, with these parameters also again being able to vary at least in part during the slicing operation.

Such variations of the product rotation, of the feed sped of the product and/or of the rotational speed of the cutting blade again result in different sections and portion shapes. In this respect, these parameters can either be set once before the putting into operation of the cutting apparatus or can vary during the slicing operation if greater irregularities are also desired within a portion or with a continuous production of product snippets.

The product feed and the cutting blade can be rotatable in the same direction or also in opposite directions. A rotation of the product feed and of the cutting blade in the same direction is in particular of advantage with non-cylindrical products.

The rotatably supported product feed preferably has an at least substantially closed contour so that it is ensured that the product to be sliced can be sufficiently fixed in the product feed and is accordingly taken along and thereby set into rotation.

A multi-track product feed can in particular also be provided via which a plurality of products to be sliced can be fed to the cutting plane next to one another and in particular simultaneously. In this respect, each track then preferably has an independently supported and drivable product feed.

The cutting edge can have a contour which is open, half-open or closed in the peripheral direction. It is preferably always aligned in parallel with the cutting plane.

If the product to be sliced is obliquely fed to the cutting plane, it is of advantage if the cutting edge comprises at least one wall or aperture facing the product feed which is set with respect to the side facing the product feed or also widens in accordance with the oblique position of the product feed with respect to the cutting plane. In particular the surfaces of the cutting edge disposed in the direction of the cutting force or the main pressing direction of the blade are preferably matched to possible angles of engagement of the product feed. A better contact of the product to be sliced thus results with an obliquely set product feed.

Whereas a stack or an overlap with an irregular margin offset results on depositing the sliced product slices with a rotating product with a non-circular or irregular outer contour which is fed to the cutting plane at a right angle, above all heaped portions of snippet parts with or more less pronounced irregularity can also in particular be generated by a variation of the other named parameters, with in particular variable sizes, thicknesses and/or formats of parts being able to be achieved.

The portions generated by means of the cutting apparatus in accordance with the invention are in particular suitable as an irregular, preferably scatterable, filling or as an ingredient for dishes, e.g. for filling baked goods, for salads or as a pizza topping. In addition, in particular fresh meat which is to be provided for corresponding dishes in snippets for browning can be pre-cut fast and in large quantities.

The previously named object is also satisfied in accordance with the invention by a method for slicing food products such as in particular sausage, cheese, ham and/or the like by means of a slicing apparatus, in particular a high-performance slicer, wherein a product to be sliced is fed to a cutting plane in which a cutting blade is moved adjacent to a cutting edge, in particular in a rotating and/or a planetary revolving motion, wherein the product fed to the cutting plane is set into rotation about an axis, in particular about a longitudinal axis of the product, at least over a predefinable angular range during the slicing operation.

A cutting apparatus in accordance with the invention is preferably used in this method.

The invention will be explained in more detail in the following by way of example with reference to the drawing. There are shown in it:

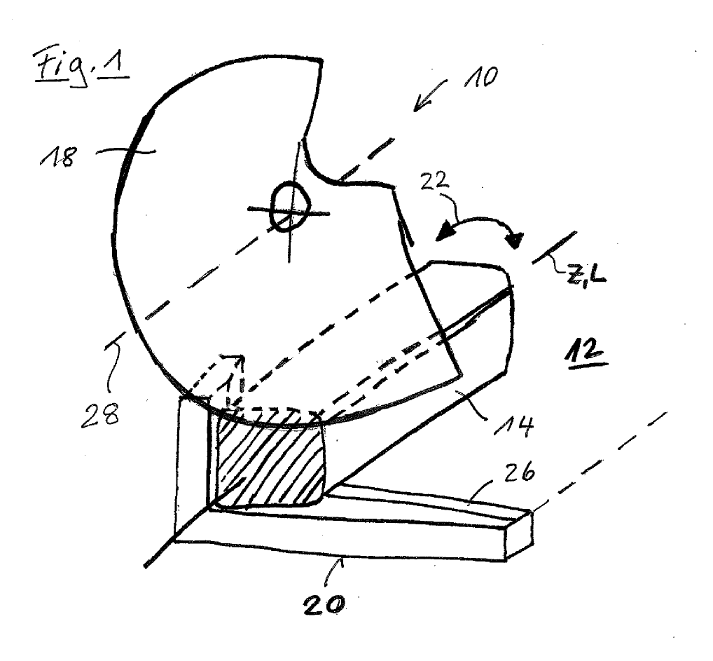

FIG. 1 a schematic representation of an exemplary embodiment of an apparatus in accordance with the invention for slicing food products;

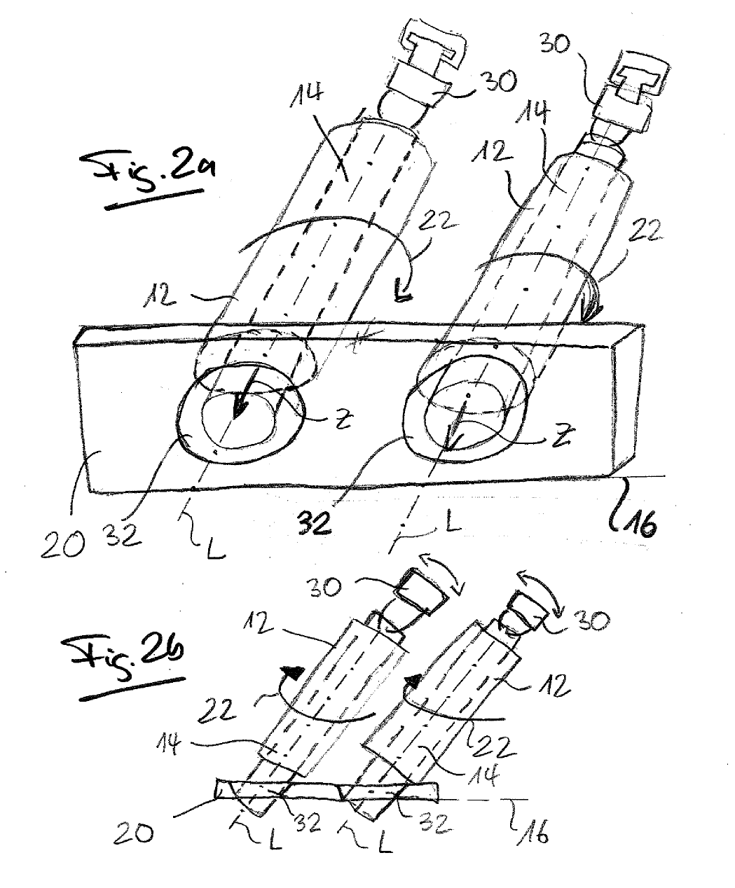

FIG. 2 schematic views (FIG. 2a in perspective and FIG. 2b in a plan view) of a further embodiment of the invention; and

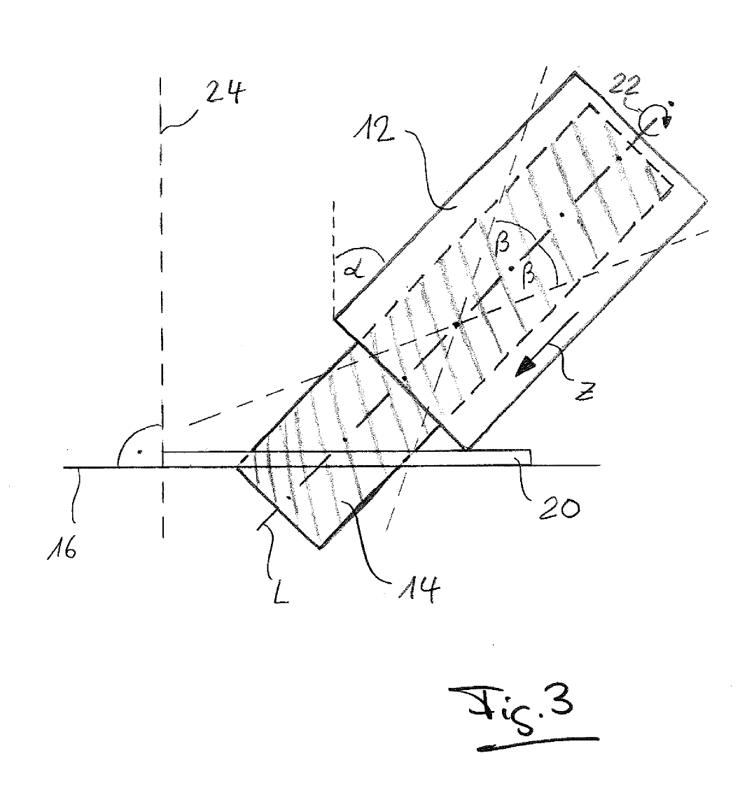

FIG. 3 a schematic plan view of a further embodiment of the invention.

FIG. 1 shows in a schematic representation an exemplary embodiment of an apparatus 10 in accordance with the invention, in particular of a high-performance slicer, for slicing food products such as in particular sausage, cheese, ham and/or the like.

The cutting apparatus 10 comprises a product feed 12 which feeds a product 14 to be sliced to a cutting plane 16 (cf. FIG. 3) in which a cutting blade 18, here formed as a scythe-like blade, moves rotating about a blade axis 28 adjacent to a cutting edge 20. The product feed 12 can have the typical components such as a product support, a product holder engaging at the rear product end and, optionally, further or other conveying devices such as traction belts.

The cutting apparatus 10 comprises means to rotate the product 14 fed to the cutting plane 16 about a longitudinal axis L of the product 14 in parallel with the feed direction Z at least over a predefinable angular angle during the slicing operation. For this purpose, the product feed 12 is preferably rotatable and the product is thus rotatable about its longitudinal axis L by means of the product feed 12. The direction of rotation of the product 14 is respectively indicated by an arrow 22 in FIGS. 1 to 3.

Both the product feed 12 and the cutting edge 20 can each be rotatable about the longitudinal axis L of the product 14, with the product feed 12 and the cutting edge 20 preferably being rotatable in the same direction.

In this respect, the product feed 12 and the cutting edge 20 can in particular be rotatable together about the longitudinal axis L of the product 14, for which purpose they can in particular be coupled mechanically or at the drive side. However, such an embodiment of the cutting apparatus 10 is also conceivable in which the cutting edge 20 is rotatable about the longitudinal axis L of the product 14 at a slower speed than the product feed 12. In the latter case, the product feed 12 and the cutting edge 20 can again also be coupled correspondingly mechanically or at the drive side.

However, such an embodiment is also conceivable, for example, in which the cutting edge 20 is taken along by the product 14 rotating about its longitudinal axis L. In this case, a mechanical coupling or a coupling at the drive side of the cutting edge 20 to the product feed 12 can be omitted.

Alternatively, the cutting edge 20 can, however, also be rotationally fixedly supported so that only the product feed 12 rotates and with it the product 12.

The product 14 to be sliced can be feedable to the cutting plane 16 by means of the product feed 12 at a right angle or in a direction differing from its normal 24 (cf. FIG. 3).

FIGS. 2a and 2b shows a multi-track variant of the invention. A product gripper 30 as a product advance feed cooperating with the rear product end and a cylindrical product feed 12 are thus provided for each product 14. The product feed 12 can be set into rotation about the longitudinal axis L of the product 14 together with the part of the product gripper 30 engaging at the product end via a drive, not shown, in order thus to rotate the product 14. The common cutting edge 20 which cooperates with the cutting blade, not shown, is provided with apertures 32 for the products 14.

In accordance with FIG. 2a, the product is fed to the cutting plane 16 in a perpendicular manner. The plan view of FIG. 2b shows that an oblique product feed, that is an angle of engagement differing from 90°, is also possible. This will be looked at in more detail in the following in connection with FIG. 3. The double arrows in FIG. 2 each indicate that the angle of engagement can be varied. The products 14 can in particular be pivoted to and fro while they each rotate about their longitudinal axis L at a varying angle of engagement during the slicing and can thus be caused to make an oscillating movement in a plane horizontal here. The walls of the apertures 32 of the cutting edge 20 are chamfered accordingly for this purpose.

FIG. 3 shows a schematic plan view of a track of a cutting apparatus in accordance with the invention, wherein in the present case the feed direction Z in which the product 14 is fed to the cutting plane 16 is set at the cutting plane 16 and forms an angle α with its normal 24.

The feed direction Z in which the product 14 to be sliced is fed to the cutting plane 16 by the product feed 12 can be variably adjustable relative to the normal 24 of the cutting plane 16 and can vary relative to the normal 24 of the cutting plane 16 during the slicing operation. In this respect, the product 14 to be sliced fed to the cutting plane 16 can in particular be pivotable in the horizontal and/or vertical direction relative to the normal 24 of the cutting plane 16 by the product feed 12 during the slicing operation. As already mentioned at another passage, the product 14 can also be caused to make a wobble movement.

A horizontal oscillating movement of the product 14 about a respective angle β at both sides of a neutral position represented by the longitudinal product axis L, and indeed about a center of rotation 34, is indicated in FIG. 3. The position of this center of rotation 34 can generally be selected as desired. The neutral position can alternatively also be selected so that the longitudinal product axis L extends in parallel with the normal 24 of the cutting plane 16 in the neutral position.

In the case of a wobble movement for the product 14, the center of rotation 34 can define the tip of a cone on whose jacket surface the central product axis L runs around and whose opening angle is equal to the angle β.

The oscillating angle or wobble angle β does not have to be either spatially symmetrical with respect to a natural position or temporally constant, i.e. a spatial and/or temporal variation of the oscillating movement or wobble movement represents a further possibility provided by the invention to achieve a particularly high degree of irregularity of the parts or snippets cut off from the product 14.

In accordance with FIG. 3, the product 14 can be set into rotation about its longitudinal axis L by means of the product feed, i.e. the axis of rotation and the longitudinal product axis L coincide here and also extend in parallel with the feed direction Z of the product 14. As likewise mentioned at another passage, this is not compulsory, i.e. in accordance with the invention, these directions or axes can also diverge to achieve a respective desired resulting orientation or movement of the front product end from which parts or snippets are cut off by means of the cutting blade, not shown.

The rotatably supported product feed 12, which can be set into rotation by a corresponding drive, can have an at least substantially closed contour so that the product 14 to be sliced can be fixed relative to the rotatable product feed 12 and can thus be set in rotation by it.

The product feed 12 can be rotatable together with the product 14 to be sliced about the longitudinal axis L of the product 14 by 360° or also only over an angular range smaller than 360°.

In the latter case, the product feed 12 can be drivable together with the product 14 to be sliced in particular to make a rocking movement about the longitudinal axis L of the product 14, i.e. the product 14 does not execute any complete rotations, but rather rotational movements of less than 360° alternately in the one and the other direction of rotation. In this respect, such a configuration of the cutting apparatus 10 is in particular conceivable in which the product feed 12 can be driven together with the product 14 to be sliced to make a varying rocking movement about the longitudinal axis L of the product 14 over a varying angular zone during the slicing operation.

As already mentioned, the product 14 to be sliced can be feedable to the cutting plane at an angle of engagement a variable during the slicing operation. Such an embodiment of the cutting apparatus 10 is, however, also conceivable in which the product 14 to be sliced can be fed to the cutting plane 16 by the product feed 12 in a constant direction differing from the normal 24.

The cutting edge 20 can have an open contour or in particular a closed contour viewed in the peripheral direction. In the latter case, the cutting edge has one or more apertures for one or more products to be sliced simultaneously and is also called a “cutting screen” (cf. e.g. FIG. 2a).

In the embodiment of FIG. 1, the cutting edge 20 is configured in the form of a bracket piece which here, for example, forms a right angle so that a product 14 at a right angle in cross-section for example, comes to contact the cutting edge 20 at two mutually adjacent sides. As long as only a rotation over a specific angular range takes place, the product 14 cannot fall out of a product receiver which is correspondingly right angled in cross-section and thus trough-like, i.e. it is then not necessary to embrace the product completely over the total periphery.

The cutting edge 20 is aligned in parallel with the cutting plane 16 at least during the cutting operation.

As can be recognized with reference to FIG. 1, the cutting edge 20 can comprise at least one wall 26 or aperture facing the product feed 12 which is set toward the side facing the product feed 12 or widens on an oblique feed of the product 14 to be sliced to the cutting plane 16.

The product feed 12 can in particular be rotatable in the same direction as the cutting blade 18 with non-cylindrical products 14 to be sliced. However, such an embodiment of the cutting apparatus 10 is also conceivable in which the product feed 12 and the cutting blade 18 are rotatable in different directions.

The speed of rotation of the product feed 12, the direction of rotation of the product feed 12, the feed speed, the direction of rotation of the cutting blade 18 and/or the rotational speed of the cutting blade 18 can be set variably. In this respect, these parameters can in particular also vary or be variably adjustable during the cutting operation.

An electronic control device can be associated with the product feed 12 and, optionally, with the cutting edge 20 or its drive or drives and they can be correspondingly controlled and/or regulated via it.

If a product 14 to be sliced having a non-circular or irregular outer contour is set into rotation by the cutting apparatus 10 and is fed at a right angle to the cutting plane 16, a stack or an overlap with an irregular marginal offset results on depositing the sliced produce slices or product parts.

However, in particular heaped portions of snippet parts having more or less pronounced irregularity and sections of in particular varying size, thickness and/or size can also in particular be formed using the cutting apparatus 10.

The portions thus generated or the snippet-like sections generated continuously without portioning are in particular suitable as an irregular, preferably scatterable, filling or as an ingredient for dishes, e.g. for filling baked goods, for salads or as a pizza topping. In addition, for example, fresh meat which is to be provided for corresponding dishes in snippets for browning can be pre-cut fast and in large quantities.

### REFERENCE NUMERAL LIST

10 cutting apparatus, high-performance slicer
12 product feed
14 product
16 cutting plane
18 cutting blade
20 cutting edge
22 arrow
24 normal of the cutting plane
26 wall
28 blade axis
30 product gripper
32 aperture
34 center of rotation
α angle
β angle
L longitudinal product axis
Z feed direction

1. An apparatus for slicing food products, comprising a product feed which feeds a product to be sliced to a cutting plane in which a cutting blade moves adjacent to a cutting edge, and means to rotate the product fed to the cutting plane about an axis at least over a predefinable angular range during the slicing operation.

2. The apparatus in accordance with claim 1, in which the axis is a longitudinal axis of the product.

3. The apparatus in accordance with claim 1, in which the cutting blade moved adjacent to the cutting edge in a rotating and/or a planetary revolving motion.

4. The apparatus in accordance with claim 1, in which the axis about which the product is rotatable coincides with a longitudinal axis of the product or includes an angle with a longitudinal axis of the product.

5. The apparatus in accordance with claim 1, in which the axis about which the product is rotatable and/or a longitudinal axis of the product coincides with the feed direction in which the product to be sliced is fed to the cutting plane by the product feed or includes an angle, such as an acute angle, with the feed direction.

6. The apparatus in accordance with claim 1, in which the product feed is rotatable and the product is rotatable via the product feed about the axis.

7. The apparatus in accordance with claim 1, in which both the product feed and the cutting edge are each rotatable about the axis.

8. The apparatus in accordance with claim 7, in which the product feed and the cutting edge are rotatable in the same direction.

9. The apparatus in accordance with claim 7, in which the product feed and the cutting edge are together rotatable about the axis.

10. The apparatus in accordance with claim 1, in which the product feed and the cutting edge are coupled mechanically and/or at the drive side.

11. The apparatus in accordance with claim 1, in which the cutting edge is rotatably supported and is taken along by the product rotating about the axis.

12. The apparatus in accordance with claim 1, in which the cutting edge is rotationally fixedly supported.

13. The apparatus in accordance with claim 1, in which the product to be sliced can be fed by the product feed to the cutting plane having a normal in a direction differing from its normal and including an angle, such as an acute angle, with the normal.

14. The apparatus in accordance with claim 1, in which the feed direction in which the product to be sliced is fed to the cutting plane having a normal by the product feed is variably adjustable relative to the normal.

15. The apparatus in accordance with claim 1, in which the feed direction in which the product to be sliced is fed to the cutting plane by the product feed can be varied during the slicing.

16. The apparatus in accordance with claim 1, in which the feed direction in which the product to be sliced is fed to the cutting plane by the product feed can be varied during the slicing such that the product executes an oscillation movement and/or wobble movement during the slicing.

17. A method for slicing food products by means of a cutting apparatus, the method comprising the steps of:
feeding a product to be sliced to a cutting plane,
moving a cutting blade in the cutting plane adjacent to a cutting edge,
setting into rotation the product fed to the cutting plane about an axis at least over a predefinable angular range during the slicing operation.

18. The method in accordance with claim 17, further comprising the step of:
varying the feed direction in which the product to be sliced is fed to the cutting plane by the product feed during the slicing.

19. The method in accordance with claim 18, in which the step of varying the feed direction in which the product to be sliced is fed to the cutting plane by the product feed during the slicing is carried out such that the product is set into an oscillation movement and/or wobble movement during the slicing.

20. The method in accordance with claim 17, the method be carried out in an apparatus for slicing food products, comprising a product feed which feeds the product to be sliced to the cutting plane in which the cutting blade moves adjacent to the cutting edge, and means to rotate the product fed to the cutting plane about an axis at least over a predefinable angular range during the slicing operation.
